(19) United States
(12) Patent Application Publication
(10) Pub. No.: US 2008/0154613 A1
(43) Pub. Date: Jun. 26, 2008

(54) VOICE COMMAND PROCESSING SYSTEM IN A VEHICLE ENVIRONMENT

(75) Inventors: Tim Haulick, Blaubeuren (DE); Markus Buck, Biberach (DE); Hans-Joerg Koepf, Amstetten (DE)

Correspondence Address: THE ECLIPSE GROUP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 11/834,591

(22) Filed: Aug. 6, 2007

(30) Foreign Application Priority Data
Aug. 4, 2006 (EP) EP 06 016 382.1

(51) Int. Cl. G10L 11/00

(52) U.S. Cl. 704/275; 704/E15.007

(57) ABSTRACT

A voice processing system for a vehicle environment is provided for detecting a sound signal in the vehicle environment and identifying a voice command that originates from a vehicle user outside the vehicle. The voice processing system, in the detected the sound signal, takes into account position information relating to the position of the vehicle user in the vehicle environment. Information on the position of the vehicle user may be obtained from a keyless-go-system or another monitoring device of the motor vehicle, for example an optical imaging device of a parking-assistance system or a driver-assistance system.

### RELATED APPLICATIONS

This application claims priority of European Patent Application Serial Number 06 016 382.1, filed on Aug. 4, 2006, titled METHOD AND SYSTEM FOR PROCESSING VOICE COMMANDS IN A VEHICLE ENVIRONMENT, which application is incorporated in its entirety by reference in this application.

### BACKGROUND

1. Field of the Invention

The invention relates to a method for processing voice commands in a vehicle environment and to a voice processing system for use in a motor vehicle. In particular, the method and system provides a voice processing system capable of increasing reliability of voice recognition quality by minimizing disturbances present in the vehicle environment.

2. Related Art

For vehicle applications, voice control systems have been developed that allow for controlling vehicle functions by voice commands. Corresponding vehicle functions may relate to a vehicle telephone system, a vehicle radio or a vehicle navigation system, i.e., vehicle functions controlled from within the vehicle cabin.

For some applications, it may also be desirable to control vehicle functions from outside the vehicle, i.e., from the vehicle environment. One example for such a vehicle function is to control opening and closing of a back door, i.e., the lift gate or tail gate by means of a voice command, so as to facilitate loading and unloading of the vehicle. Currently, it is not possible for the vehicle user to open, close, lock or unlock a vehicle door utilizing a conventional key without putting down the item to be stored in the motor vehicle. Therefore, it is a significant advantage for the vehicle user to have the possibility of opening, closing, unlocking and/or locking the vehicle door by voice command, including but not limited to the back door of the motor vehicle, but also to other vehicle doors, depending on the vehicle type.

However, in the vehicle environment, the recognition of voice commands is seriously affected by noise present in the vehicle environment. Moreover, the source of the noise present in the vehicle environment may be non-stationary, such as passing vehicles or people. Typical sources of noise in the vehicle environment are wind and rain, other vehicles or people.

The noise present in the vehicle environment may lead to a false detection of voice commands, may reduce the reliability of the detection of voice commands, or may even make the detection of voice commands impossible. Accordingly, a need exists to improve the detection and processing of sound signals detected from the vehicle environment so as to reliably identify a voice command.

### SUMMARY

In accordance with one example of an implementation, a method for processing voice commands in a vehicle environment is provided, which includes (i) detecting a sound signal in the vehicle environment and (ii) identifying a voice command, which originates from a vehicle user, in the detected sound signal, taking into account a position information relating to the position of the vehicle user in the vehicle environment. The voice command may be used to control a vehicle function. Accordingly, it may be possible to significantly reduce the influence of noise present in the vehicle environment. In particular, the information concerning the position of the vehicle user generally allows for distinguishing between signal components originating from the vehicle user and other signal components, i.e. noise. The information relating to the position of the vehicle user can be taken into account in the process of detecting the sound signal, e.g. by suppressing sound signals originating from other positions than the position of the vehicle user, and/or in the process of identifying the voice command, e.g. by correlating the detected sound signal with the information concerning the position of the vehicle user.

In accordance with another example of an implementation, a system for processing voice commands in a vehicle environment is provided. The system includes a means for detecting a sound signal in the vehicle environment, which may include a microphone system or a non-acoustic system, a first processing unit for retrieving position information relating to the position of a vehicle user outside the vehicle and second processing unit for identifying a voice command, which originates from the vehicle user, in the detected sound signal. The system is configured in such a manner that detecting of the sound signal and/or identifying of the voice command may be accomplished taking into account the position information, which may provide improved reliability in the process of detecting and recognizing the voice command. The system may also include a means for detecting the position of the vehicle user or a monitoring system, which may include keyless-go-system, parking-assistance system, driver-assistance system, laser-scanner system and/or optical imaging system and which may be supplied with signals from a radio device, an ultrasonic device, an optical imaging device, a laser scanner, or a microphone array or may even comprise at least one of these devices.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 shows a schematic view of a vehicle equipped with a voice processing system.

FIG. 2 is a block diagram illustrating one example of an implementation of a voice processing system.

FIG. 3 is a block diagram illustrating another example of an implementation of a voice processing system.

FIG. 4 illustrates a flow chart of one example of a method of processing voice commands using the voice processing system illustrated in FIGS. 2 & 3.

### DETAILED DESCRIPTION

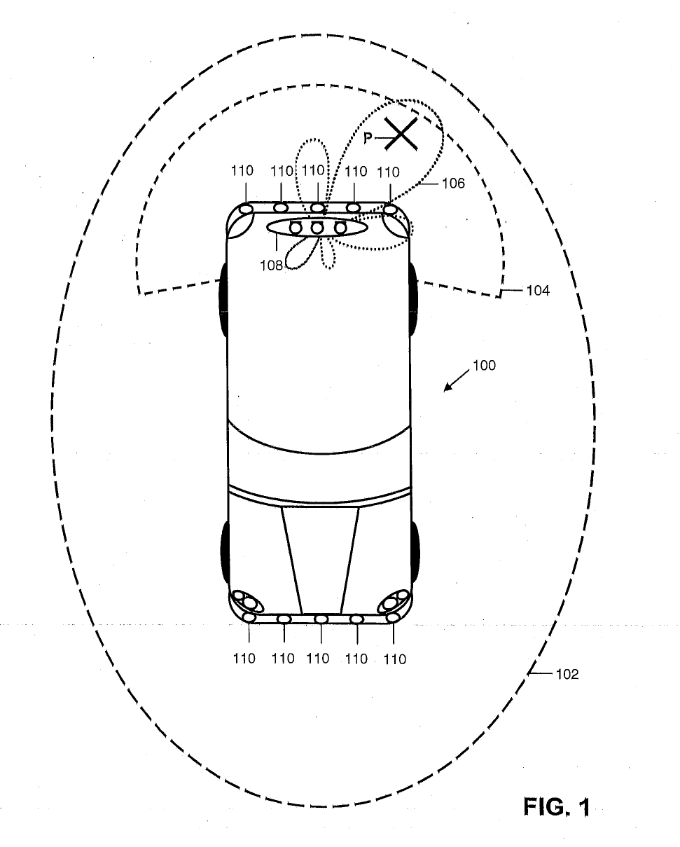

FIG. 1 shows a schematic view of a vehicle equipped with a voice processing system. In FIG. 1, a motor vehicle 100 is illustrated that is equipped with a voice processing system. As illustrated, the motor vehicle 100 is also equipped with system(s) that allows for detecting the position of a vehicle user. In the FIG. 1, the position of the vehicle user is indicated by a cross denoted by P.

In this example of an implementation, the motor vehicle 100 is equipped with a keyless-go-system. The keyless-go-system allows the vehicle user to lock, unlock and start the motor vehicle without using a conventional key. For the keyless-go-system, the vehicle user has a code card (not illustrated) that is detected when the vehicle user approaches the motor vehicle 100. The range of detection for detecting the code card in the vehicle environment is denoted by the long dashed line 102. The detection may, for example, be accomplished on the basis of radio signals. By transmitting radio signals, a key code may be transmitted between the code card and the motor vehicle 100 so as to identify an authorized vehicle user. Of course, other means than a code card may be used by the keyless-go-system for identifying an authorized vehicle user, for example, a chip embedded in a conventional key.

In one example, the motor vehicle 100 may be further equipped with a parking-assistance system. The parking-assistance system comprises a plurality of sensors 110 which are arranged to detect obstacles in the vicinity of the vehicle. The parking-assistance system may use different types of sensors, including ultrasonic sensors and optical sensors, such as camera devices. In the illustrated example, the sensors 110 are arranged along the front and rear bumpers of the motor vehicle. The range of detection of the sensors 110 in the rear bumper is indicated by the short dashed line denoted by 104. By combining the measurements obtained using the plurality of sensors 110, it is possible to determine the position P of the vehicle user within the range of detection 104. The same applies for the range of detection of the sensors 110 arranged in the front bumper, which range, however, is not illustrated in the figure.

Further, the motor vehicle 100 may be equipped with a microphone system 108 that allows for detecting sound signals in the vehicle environment. In the illustrated example, the microphone system 108 includes a microphone array that allows for directing a sound-detection zone, i.e., a zone of increased sensitivity of the microphone array, into a specific direction. The sound-detection zone of the microphone array is schematically illustrated by the dotted lines denoted by 106. In particular, it is possible to direct the sound-detection zone toward the position P of the vehicle user.

In connection with the microphone system 108, the keyless-go-system may have a function for identifying the vehicle user on the basis of detected sound signals, i.e., by identifying the individual voice pattern of the vehicle user. Thereby, a supplemental or alternative function for verifying the vehicle user's authorization is provided. In addition, it is also possible to detect the position P of the vehicle user utilizing the microphone array of the microphone system 108. In particular, the microphone array comprises a plurality of microphone devices, and by evaluating the output signals of the different microphone devices taking into account their specific locations, the position P of the vehicle user can calculated.

In the illustrated example, the microphone system 108 is used to detect voice commands originating from the vehicle user so as to control at least one vehicle function. In particular, such a function may be opening, closing, locking, and/or unlocking of a vehicle door, in particular the back door, e.g., a lift gate or a tail gate. This may significantly facilitate loading and unloading the motor vehicle 100. Namely, the vehicle user may use both hands to carry items to be stored in the vehicle. Thus, the vehicle doors to be controlled by a voice command are suitably automated.

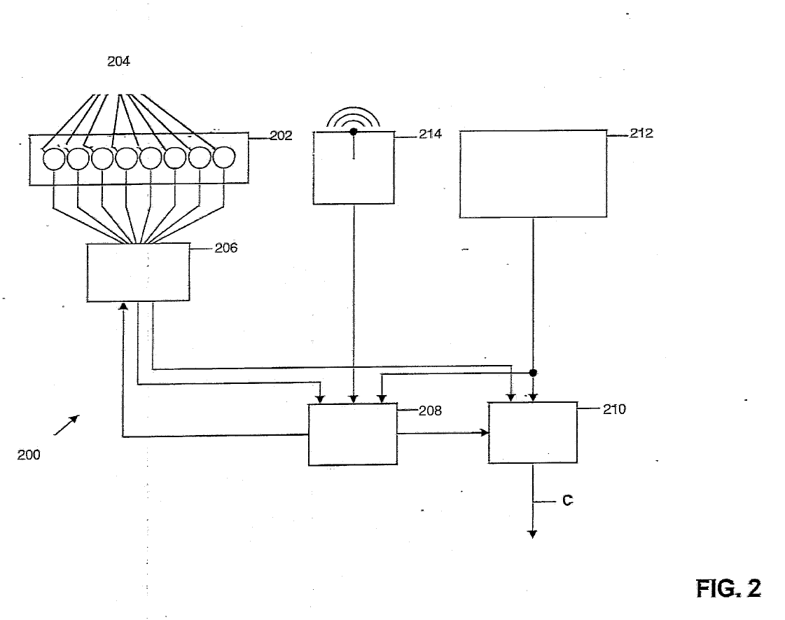

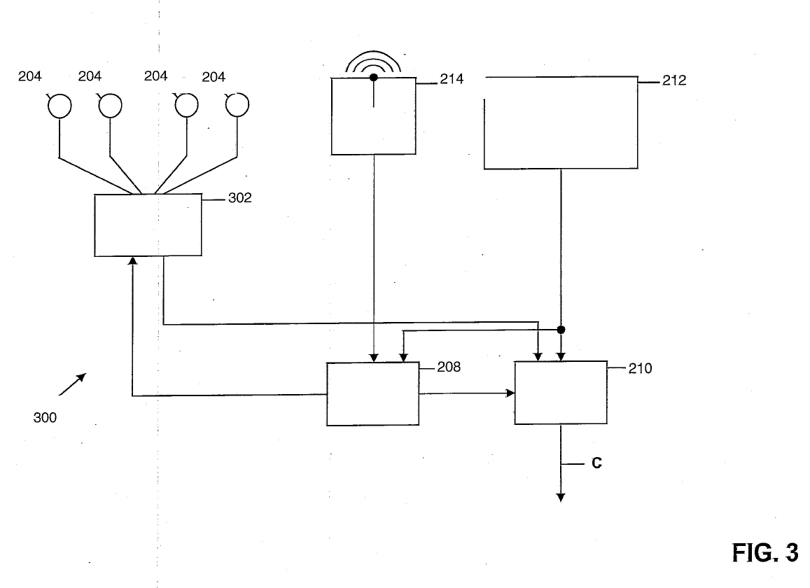

As explained further in connections with FIGS. 2 and 3 below, the microphone system 108 generally includes a microphone array having a plurality of microphone devices arranged in a well-defined spatial relationship. With such a microphone array, it is possible to use a beam-forming method so as to adapt the microphone system 108 to the position P of the vehicle user. In particular, a sound-detection zone of the microphone array can be precisely directed toward the position of the vehicle user, as schematically illustrated in FIG. 1.

Moreover, it is also possible to selectively activate or deactivate the control of certain vehicle functions depending on the position P of the vehicle user. For example, the control of the vehicle back door could be activated only if the position P of the vehicle user is in the rear area of the motor vehicle 100. In this manner, many cases of false detection of voice commands or disturbances can be excluded, thereby increasing the reliability of the voice processing system.

By identifying the vehicle user on the basis of the detected sound signal, the functionality of the system may also be enhanced. For example, the control of certain vehicle functions can be selectively activated or deactivated depending on the vehicle user's authorization. Moreover, it is possible to identify the individual giving the voice command and only accept voice commands from predefined individuals.

In the example of FIG. 1, the motor vehicle 100 is illustrated to have the keyless-go-system and the parking-assistance system, which allow for obtaining information on the position of the vehicle user. However, the motor vehicle 100 may also be equipped with other or additional systems that allow for determining the required position information. For example, the motor vehicle 100 may be equipped with a laser-scanner system. Laser-scanner systems typically use a laser beam of the infrared spectrum for scanning the environment of a motor vehicle in a generally circumferential pattern. The laser-scanner system may be used in a parking-assistance system or in a driver-assistance system, e.g., for detecting objects on or near the road or for automatic control of the vehicle speed in stop-and-go situations. The laser-scanner system can be mounted behind the radiator cowling or be integrated in the front or rear bumpers, similar to the sensors 110.

With regard to the detection of the position of the vehicle user, the laser-scanner system may also be utilized as it typically provides a large angular range of detection, a large radial range of detection and a high angular and radial resolution. The range of detection typically extends more than 200 m from the motor vehicle. Therefore, information obtained by utilizing a laser-scanner system is highly valuable in the voice processing system described above.

In addition, the motor vehicle 100 may be equipped with optical imaging systems, e.g., a vehicle camera. In normal operation, the optical imaging system may be used, for example, to provide images of the rear area of the motor vehicle when driving backwards. In connection with the voice processing system, information obtained by means of the optical imaging system may be used to improve the reliability of the voice processing system. For example, it is possible to use the optical imaging system for determining the position of the vehicle user. Further, the processing of sound signals during voice recognition may be combined with an image analysis.

It is also possible to activate the voice processing system only when the optical imaging system detects a person and the lips of the person move. When several persons are within the image range, the sound-detection zone of a microphone array can be directed toward the person who is speaking, i.e., whose lips are moving. Further improvements may also be achieved by evaluating the motion of the lips in a more detailed manner and by using the results of this evaluation to supplement the voice recognition. Accordingly, the processing of acoustical signals can be combined with an image analysis of a “lip-reading type”.

Further, it is possible to combine the information obtained by different monitoring systems of the motor vehicle 100, such as keyless-go-system, parking-assistance system, driver-assistance system, laser-scanner system and/or optical imaging system. For example, a coarse localization of the vehicle user can be accomplished utilizing the keyless-go-system, and subsequently a more precise localization can be obtained by means of a laser-scanner system, an optical imaging system or other suitable type of monitoring system.

In operation, the voice processing system in the motor vehicle 100 may first detect whether or not the vehicle user is approaching the motor vehicle 100, by utilizing, for example, a keyless-go-system. If the vehicle user is within the range of detection 102 of the keyless-go-system, the microphone system 108 may then be activated so as to detect a voice command originating from the vehicle user. The keyless-go-system may not only allow for detecting the presence of the vehicle user within the detection range 102, but also allow for localizing the vehicle user within the detection range 102. In particular, it can be distinguished whether the vehicle user approaches from the left side of the motor vehicle, from the right side of the motor vehicle, from the rear side of the motor vehicle or from the front side of the motor vehicle. Therefore, the keyless-go-system provides information on the position P of the vehicle user.

Additional information on the position P of the vehicle user may be obtained by utilizing a parking-assistance system, i.e., by sensors 110, and the microphone system 108. Having detected the presence of the vehicle user in the vehicle environment and having determined the position P of the vehicle user, the microphone system 108 may be adjusted to the position P of the vehicle user. For example, this may be accomplished by simply activating or deactivating microphone devices of the microphone system 108. In particular, microphone devices that are located near the vehicle user may be activated whereas other microphone devices that are located further away from the vehicle user are deactivated or are used as a source of reference signals for compensating noise which is present in the vehicle environment.

FIG. 2 is a block diagram illustrating one example of an implementation of a voice processing system 200. The voice processing system 200 includes a first processing unit 208 for evaluating information or signals concerning the position of the vehicle user and a second processing unit 210 for evaluating sound signals detected by a microphone system 202. The second processing unit 210 generates a control signal C for controlling a vehicle function.

As illustrated, the voice processing system 200 includes a microphone system 202 and a control unit 206 of the microphone system 202. The microphone system 202 has the form of a microphone array comprising a plurality of microphone devices 204 arranged in a well-determined spatial relationship. The control unit 206 combines the sound signals detected by the different microphone devices 204 so as to supply a single sound signal to the second processing unit 210. In the control unit 206, a weight is assigned to each of the output signals of the microphone devices 204, and the weighted output signals are added so as to obtain the single sound signal as output from the control unit 206. The weights are adjusted on the basis of a position information signal supplied from the first processing unit 208.

The first processing unit 208 receives input signals that allow for determining the position of the vehicle user. These input signals are supplied from, for example, a keyless-go-system 214 and from a monitoring system 212. The monitoring system 212 may comprise an optical imaging system or a laser-scanner system. In addition, an input signal is supplied from the control unit 206. This is possible as the microphone array not only allows for directing a sound-detection zone toward a specific position, but also allows for determining the position of the source of a sound signal by evaluating the output signals of the different microphone devices 204.

The first processing unit 208 supplies a position-information signal to the second processing unit 210, which evaluates its input signals taking into account the position of the vehicle user as supplied from the first processing unit 208. The second processing unit 210 receives, as its input signal, the sound signal from the control unit 206 and an image information signal from the monitoring system 212. On the basis of the supplied input signals, the second processing unit 210 evaluates whether or not the sound signal supplied by the control unit 206 corresponds to a specific voice command. If a voice command is identified, the corresponding control signal C is generated. The input signals supplied from the first processing unit 208 and from the monitoring system 212 may also be used to activate or deactivate the second processing unit 210.

In addition, the detected sound signal may also be evaluated so as to identify the vehicle user. This may be accomplished by the second processing unit 210, which then provides corresponding information to the keyless-go-system 214. Of course, it is also possible to forward the detected sound signal to the keyless-go-system 214, which then performs the necessary processing for identifying the vehicle user.

It is to be understood that the keyless-go-system 214 and the monitoring system 212 do not necessarily form parts of the voice processing system 200. Rather, they may constitute “already existing” systems that are suitable to provide information on the position of the vehicle user. The use of already existing systems for obtaining information on the position of the vehicle user may allow improved reliability of the voice processing system 200 with a minimum of additional outlay.

FIG. 3 is a block diagram illustrating another example of an implementation of a voice processing system 300. The voice processing system 300 generally corresponds to that of FIG. 2, and similar components have been designated with the same reference signs.

As compared to the voice processing system 200 of FIG. 2, the voice processing system 300 of FIG. 3 includes a plurality of separate microphone devices 204 that are connected to a control unit 302. The microphone devices 204 may be located at different positions on the motor vehicle. The control unit 302 selectively supplies the output signal of one of the microphone devices 204 to the second processing unit 210, i.e., the control unit 302 selectively activates or deactivates the microphone devices 204 so as to supply their output signal to the second processing unit 210. This may be accomplished on the basis of the position-information signal received from the first processing unit 208. For example, only that microphone device 204 that is located closest to the position of the vehicle user may be activated. The other microphone devices 204 may be deactivated. Alternatively, the output signals of the other microphone devices 204 can also be supplied to the second processing unit 210 as reference signals and be used for compensating noise present in the vehicle environment.

It is to be understood that in the voice processing systems 200, 300 as illustrated in FIGS. 2 and 3, the first processing unit 208 and the second processing unit 210 may be separate components, or a single component, but will typically be implemented by suitable software running on a microprocessor. A single microprocessor may also be utilized to implement functions of the keyless-go-system 214 and/or of the monitoring system 212, thereby unifying the functions of the voice processing system 200, 300 and of other vehicle control systems in a single microprocessor. In this way, the need for additional hardware may be reduced.

In one example of an implementation, sound detection is performed by a microphone array and beam-forming method configured to direct a sound-detection zone of the microphone array toward the position of the vehicle user. In this regard, the receiving characteristics of the microphone array can be precisely adapted to the position of the vehicle user.

According to a further implementation, the second processing unit 210 may be configured to identify the voice command taking into account information from an optical imaging device, e.g., a camera monitoring the outside area of the vehicle, which may form part of the monitoring system 212. In particular, the camera may be used to detect the face of the vehicle user and motion of the lips of the vehicle user can be evaluated. That is to say, the second processing unit 210 may utilize a combination of acoustical voice recognition and optical image analysis of a lip-reading type to identify the voice command. For example, if no lip motion is detected by the imaging device, a detected sound signal may be discarded. However, it could also be possible to evaluate the motion of the lips in more detail. In any case, the additional use of image information may improve the reliability of voice recognition. The second processing unit 210 may also be configured to identify the vehicle user on the basis of the detected sound signal.

As illustrated in FIGS. 1-3, the voice processing system 100 is generally provided for use in a motor vehicle 100. The motor vehicle may include additional systems that may be used in connection with the voice processing system so as to improve the reliability of voice recognition. In particular, the motor vehicle may include a keyless-go-system that communicates with the voice processing system so as to provide information on the position of the vehicle user. The motor vehicle may also include a parking-assistance system, the parking-assistance system communicating with the voice processing system so as to provide information on the position of the vehicle user. The motor vehicle may also include other types of systems suitable for monitoring the vehicle environment and that may communicate with the voice processing system so as to provide information on the position of the vehicle user. Such a monitoring system may also include optical imaging devices such as cameras or laser scanners that allow for a highly precise detection of the position of the vehicle user or may be used to provide other valuable information. In particular, the voice processing system may be provided with additional image information so as to supplement the acoustical voice recognition with an image analysis of the lip-reading type.

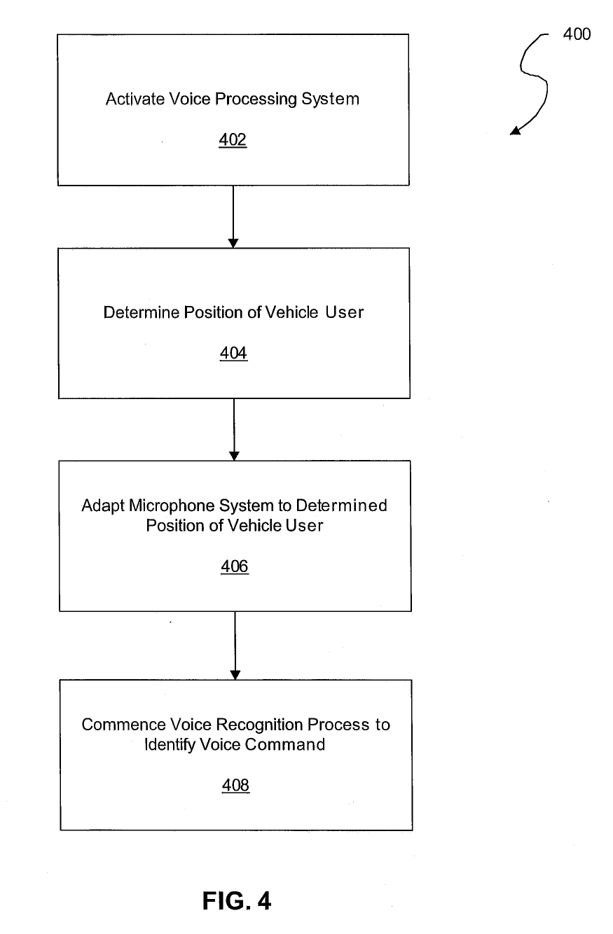

FIG. 4 illustrates a flow chart of one example of a method of processing voice commands using the voice processing system illustrated in FIGS. 2 & 3. In step 402, the voice processing system is activated by a signal received from the keyless-go-system 214 indicating that the vehicle user approaches the motor vehicle 100. In step 404, the position P of the vehicle user is determined. This is accomplished on the basis of information received from the keyless-go-system 214, the monitoring system 212 and/or the microphone system 202.

In step 406, the microphone system 202 is adapted to the determined position P of the vehicle user. This is accomplished by directing the sound-detection zone of the microphone array toward the position P of the vehicle user or by selectively activating or deactivating the microphone devices 204 depending on their location relative to the position P of the vehicle user.

For example, in one implementation, the position of the vehicle user may be detected on the basis of acoustical signals, e.g., by using a microphone array for detecting the sound signal. In a microphone array, different channels, each relating to one of a plurality of microphone devices 204 (FIGS. 2 & 3), may be used to obtain information concerning the origin of a sound signal. In addition, or as an alternative, information concerning the position of the vehicle user may be obtained on the basis of non-acoustical signals, such as optical signals, ultrasonic signals, or radio signals. In this regard, it is possible to locate the vehicle user before the vehicle user speaks a voice command. Accordingly, non-acoustical signals may enhance the detection and subsequent recognition of the voice command.

In one example of an implementation, information concerning the position of the vehicle user may be obtained by utilizing already existing system suitable for monitoring the environment of a vehicle. In particular, such a system may be a so-called keyless-go-system 214 (FIGS. 2 & 3) typically used for unlocking the doors of a vehicle when the vehicle user approaches. Other possibilities are an optical imaging system, e.g., relating to a parking-assistance system or to a driver-assistance system, a laser-scanner system, or similar monitoring systems. The use of a laser-scanner system may allow, for example, more precise detection of the position of the vehicle user.

According to a further implementation, the position of the vehicle user may be taken into account during detecting of the sound signal by using a microphone array in connection with a beam-forming method. By utilizing a beam-forming method, a sound-detection zone of the microphone array can be directed toward the position of a vehicle user. Thus, the detection of the sound signal can be adapted to the position of the vehicle user.

In step 408, a voice recognition process is started so as to identify a voice command in the detected sound signal. If a voice command is identified, a corresponding control signal for controlling the vehicle function may be further generated. In step 408, image information provided by an optical imaging system of the monitoring system 212 may additionally be used so as to improve the reliability of voice recognition. Further, the step 408 may also include identifying the vehicle user on the basis of the detected sound signal.

In a further example, multiple microphone devices 204 (FIGS. 2 & 3) may be provided for detecting the sound signal and preferably positioned at different locations on the vehicle. In this case, the microphone devices 204 may be selectively activated or deactivated depending on the position of a vehicle user. For example, only the microphone device located closest to the position of the vehicle user may be used for detecting the sound signal. The other microphone devices 204 may be inactive or may be used as a source of reference signals.

According to a further example, step 408, e.g., detecting the sound signal and/or identifying the voice command, is only activated when the position of the vehicle user is within a predetermined area, e.g. the operating range of a keyless-go-system. In this manner, it can be excluded that a false detection of voice signal occurs when the vehicle user is not near the vehicle, e.g., by accidentally detected speech originating from other persons. It is also possible to exclude specific voice commands from identification when the vehicle user is not located in a specific area. For example, a voice command for opening or closing of a back door of the vehicle can be enabled only when the vehicle user is located near the rear of the vehicle.

As already mentioned, the voice command is preferably used to control a vehicle function, such as opening or closing of a vehicle door, such as a back door. The method may also include identifying the vehicle user on the basis of the detected sound signal. In this manner, they system can be further assure that the vehicle user is authorized to control certain vehicle functions. Identifying of the vehicle user can be accomplished by a keyless-go-system or by a voice processing system that also provides the function of identifying the voice command.

To summarize, a voice processing system and a voice processing method have been described that offer reliability of voice recognition. In particular, the influence of noise present in the vehicle environment and of other disturbances on the recognition of voice commands spoken by the vehicle user may be reduced. Further, the required information concerning the position of the vehicle user can be obtained from monitoring systems already existing in the motor vehicle for other purposes, thereby minimizing the need for additional hardware.

The foregoing description of implementations has been presented for purposes of illustration and description. It is not exhaustive and does not limit the claimed inventions to the precise form disclosed. Modifications and variations are possible in light of the above description or may be acquired from practicing the invention. For example, persons skilled in the art will understand and appreciate, that one or more processes, sub-processes, or process steps described in connection with FIGS. 1-4 may be performed by hardware and/or software. Additionally, a voice processing system, as described above, may be implemented in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions, i.e., “logic” that may be implemented either in digital form such as digital circuitry or source code or optical circuitry or chemical or biochemical in analog form such as analog circuitry or an analog source such an analog electrical, sound or video signal, and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (hereinafter, “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer, i.e., machine data signals embodied in the carrier wave signal. The computer/machine data signals may include data or software that is transported or interacts with the carrier wave signal. Note also that the implementation may vary between systems. The claims and their equivalents define the scope of the invention.

What is claimed is:

1. A method for processing voice commands in a vehicle environment, the method comprising:
detecting a sound signal in the vehicle environment;
retrieving position information relating to the position of a vehicle user outside the vehicle; and
identifying a voice command, that originates from the vehicle user in the detected sound signal, where the detecting of the sound signal and/or the identifying of the voice command is accomplished taking into account the position information.

2. The method of claim 1, further comprising detecting the position of the vehicle user so as to generate the position information.

3. The method of claim 2, where the position of the vehicle user is detected utilizing a keyless-go-system.

4. The method of claim 2, where the position of the vehicle user is detected utilizing an optical imaging system.

5. The method of claim 2, where the position of the vehicle user is detected utilizing a laser-scanner system.

6. The method of claim 2, where the position of the vehicle user is detected utilizing a microphone array.

7. The method of claim 2, where the position of the vehicle user is detected utilizing sensors of a parking-assistance system.

8. The method of claim 2, where the sound signal is detected utilizing a microphone array.

9. The method of claim 8, where the microphone array is used with a beam-forming method so as to direct a sound-detection zone of the microphone array toward the position of the vehicle user.

10. The method of claim 1, where the identifying of the voice command is accomplished taking into account information from an optical imaging system.

11. The method of claim 1, where multiple microphone devices are provided for detecting the sound signal, and the microphone devices are selectively activated or deactivated depending on the position of the vehicle user.

12. The method of claim 11, where a microphone device located near the position of the vehicle user is used for detecting the sound signal and the other microphone devices are used as a source of reference signals.

13. The method of claim 1, where the sound signal is only detected when the position of the vehicle user is within a predetermined range.

14. The method of claim 1, where the voice command is only identified when the position of the vehicle user is within a predetermined range.

15. The method of claim 1, further comprising controlling a vehicle function in accordance with the identified voice command.

16. The method of claim 1, further comprising identifying the vehicle user on the basis of the detected sound signal.

17. A system for processing voice commands in a vehicle environment, the system comprising:
a sound detecting means for detecting a sound signal in the vehicle environment;
a first processing unit for retrieving a position information relating to the position of a vehicle user outside the vehicle;
a second processing unit for identifying a voice command that originates from a vehicle user in the detected sound signal, where the detecting of the sound signal and/or the identifying of the voice command is accomplished taking into account the position information.

18. The system of claim 17, where the first processing unit is supplied with signals consisting of: a radio device, an ultrasonic device, an optical imaging device, a laser-scanner system, or a microphone array.

19. The system of claim 17, further including a means for detecting the position of the vehicle user.

20. The system of claim 17, where the sound detecting means comprises:
a microphone array; and
beam-forming means configured to direct a sound-detection zone of the microphone array toward the position of the vehicle user.

21. The system of claim 17, where the sound detecting means comprises:
a plurality of microphone devices; and
control unit configured to selectively activate or deactivate the microphone devices depending on the position of the vehicle user.

22. The system of claim 17, where the second processing unit is configured to identify the voice command taking into account information from an optical imaging device.

23. The system of claim 17, where the second processing unit is configured to identify the vehicle user on the basis of the detected sound signal.

24. A motor vehicle, the motor vehicle comprising:
a voice processing system, the voice processing system comprising:
a sound detecting means for detecting a sound signal in the vehicle environment;
a first processing unit for retrieving a position information relating to the position of a vehicle user outside the vehicle;
a second processing unit for identifying a voice command that originates from a vehicle user in the detected sound signal, where the detecting of the sound signal and/or the identifying of the voice command is accomplished taking into account the position information,
where the voice processing system is used to a motor vehicle function.

25. The motor vehicle of to claim 24, further comprising a keyless-go-system, where the keyless-go-system communicates with the voice processing system so as to provide information on the position of the vehicle user.

26. The motor vehicle of to claim 25, where the keyless-go-system is configured to identify the vehicle user on the basis of the detected sound signal.

27. The motor vehicle of claim 24, further comprising a monitoring system, where the monitoring system communicates with the voice processing system so as to provide information on the position of the vehicle user.

28. The motor vehicle of claim 27, where the monitoring system relates to a parking-assistance system or a driver-assistance system.

29. The motor vehicle of claim 28, where the monitoring system includes an optical imaging device and the optical imaging device communicates with the voice processing system so as to provide image information.
